(19) United States
(12) Patent Application Publication
(10) Pub. No.: US 2010/0288133 A1
(43) Pub. Date: Nov. 18, 2010

(54) Pot-like container which is open at the top

(76) Inventors: Bernd Litzka, Wien (AT); Stefan Kreppel, Wien (AT)

Correspondence Address: LUCAS & MERCANTI, LLP, 475 PARK AVENUE SOUTH, 15TH FLOOR, NEW YORK, NY, 10016, US

(21) Appl. No.: 12/310,807

(22) PCT Filed: Sep. 7, 2007
(86) PCT No.: PCT/AT2007/000427

§ 371 Date: Jul. 30, 2010

(30) Foreign Application Priority Data
Sep. 8, 2006 (AT) A 1507/2006

(51) Int. Cl. A47J 31/06

(52) U.S. Cl. 99/299

(57) ABSTRACT

Pot-like container which is open at the top and has a flange-like rim which surrounds the opening and projects outwards, wherein a filter (2) is arranged on the inside of the container (1), the upper face of the flange-like rim (5) is provided with an adhesive surface (6) on which an annular cover (7) is removably arranged, and a lid (9) for closing the container (1) is pivotably arranged in the region of the upper rim of the container (1).

The invention relates to a cup-shaped container with an open top, with an outwardly projecting flange-like rim which protrudes outwardly and surrounds the opening which is closable by means of a collar, and with a filter arranged on the inner side of the container.

Systems for encapsulating coffee powder in closed, pressure-tight containers are already in existence, wherein the purpose and use particularly are directed to the maintenance of the aromas in the closed capsule over a longer period of time and, therefore, the already encapsulated coffee or tea is offered to the consumer. Another known use concerns packaged coffee portions in pressure-permeable, but already enclosed containers which are packed individually for sale or in larger quantities in an aroma-tight manner. Coffee machines which are suitable for use of fully encapsulated coffee powder are known in the prior art.

EP 1243210 A1 as well as WO 02080744 describe a method in which a pressure-tight enclosed capsule is pressurized on one side by hot water which enters through holes, and in which on the oppositely located side the capsule is blown outwardly as a result of the pressure and bursts along an intended breaking point against a mandrel in order to permit the enriched water to escape. Filling of the capsule with coffee powder is not illustrated.

WO 02081327 A2 describes a closed capsule which has a diaphragm at the bottom of the container which is slightly punctured by an external mandrel of a machine. The capsule cannot be filled itself.

EP 1273528 discloses a closed capsule which contains solids between two round filtered layers which are welded together at the outer circumference. In this arrangement, hot water can enter through a filter layer and can escape as a result of slight excess pressure through the solids and the second filter layer. The capsule itself cannot be filled.

SI 1190959 T discloses a pressure-tight sealed capsule which has at the capsule bottom an elastic, round valve in the form of a permeable foil which is connected fixedly to the capsule bottom concentrically as well as at the circular circumference of the foil. The capsule cannot be filled itself.

JP 60045325 describes a pressure-tight closed capsule having a stepped conical shape with a unilaterally pressure-sensitive diaphragm. The diaphragm bursts when hot water flows in. The capsule cannot be filled itself.

GB 1168470 discloses a permanently sealed capsule in which the cup-shaped capsule housing as well as the radially sealed diaphragm are perforated in order to facilitate the flow of hot water through, for example, coffee. The capsule cannot be filled itself.

EP 0008015 B1 describes a method for manufacturing coffee capsules with coffee or imitation coffee powder as well as aroma additives, such as, coffee oil. Filling is not described.

It follows from the documents listed above that capsules with cup-shaped, for example, conically shaped containers and pressure-sensitive diaphragms surround the aroma-containing solid material in an airtight manner. Consequently, the already sealed coffee capsules constitute the current state of the art. In this regard there is the problem that customers must exclusively utilize coffee powder of the capsule manufacturer which has been filled into capsules and that alternative coffee blends are excluded from use in such suitable coffee machines.

In addition, DE 1404799 A1 discloses a preferably completely filled and sealed container which, however, is also described as being fillable automatically. In the container, a porous separating disk is placed which divides the interior space of the container into two chambers arranged one above the other, wherein the lower chamber located between container bottom and separating wall contains milk powder and the chamber thereabove is filled with coffee powder. An annular flange is provided at the upper edge of the container to which a cover is fastened in an airtight manner by means of hot sealing. Through inward openings provided in the cover, water is conducted into the container and flows out through an outlet opening provided in the container bottom as a solution extract of the container contents.

DE 1989147 U discloses a container serving as a coffee package whose bottom is constructed as a porous filter or a sieve with a filter located thereabove and with a cover also having a sieve. The cover is preferably removable for again filling the cup-shaped container with coffee powder or is fastened directly to the container wall for folding it down by means of a hinge.

U.S. Pat. No. 5,840,189 A1 discloses a container which is open at the top with a flange-like rim which projects outwardly and surrounds the opening of the container, and a filter arranged on the inner side of the container, wherein the lower part of the filter is resting on the floor of the container in a flat shape. This container is, however, constructed as a disposable container which is filled with coffee already in the manufacture and is closed in an airtight manner by a seal.

It is the object of the invention to provide, on the one hand, capsules which can be filled individually as desired with coffee or tea and which can be used in coffee machines which are suitable for use of already encapsulated coffee powder. On the other hand, the container used for this purpose should also be constructed in such a way that the process of filling takes place as much as possible simply, cleanly, and friendly to operate.

The solution of the above object resides in that a cup-shaped container with an open top of the above-described type is provided with an outwardly projecting hinge-like rim which surrounds the opening, and a filter arranged on the inner side of the container which, in accordance with the invention, is characterized in that the flange-like rim is on its upper side provided with an adhesive surface on which an annular cover is arranged which can be removed, and in that in the area of the upper rim of the container a cover for closing the container is pivotally arranged.

In the present case, the term “filter” is to be understood in connection with the invention that water conducted into the filter flows through the filter from the outside and contacts the coffee powder arranged in the filter in order to prepare coffee and then serves as a retaining medium for the solids and prevents in this manner the return flow of the coffee sludge in the nozzle of the coffee machine.

The container has a conventional shape of a cup-shaped, for example, stepped conical capsule which is open at the top and which has a flange-like rim on the open side, wherein the rim has an adhesive surface which is protected by an easily removable cover, wherein a cover is arranged at the open side of the container which, after filling the hollow space with aromatic solids, such as, for example, ground coffee, and after removing the easily removable cover is secured by the adhesive surface. Due to the annular removable cover, the adhesive surface is protected in such a way that no powder adheres when the hollow space is filled manually.

In accordance with a further development, for facilitating the removal of the cover from the adhesive surface of the flange-like rim, the invention is characterized in that a pull lug is arranged at the annular cover, preferably outside of the area of the cover pivotally arranged at the container. The pivoting capability of the cover is ensured in accordance with the invention through a folded edge, wherein it is not necessary to provide a hinge, as it is known from DE 198147 U in which the hinge is arranged so as to project outwardly from the upper rim of the container. Such an embodiment makes it impossible to use in coffee machines which are conventionally suitable for use of already encapsulated coffee powder.

In accordance with the configuration according to the present invention, after filling the capsule, the annular cover is removed and the adhesive surface is exposed. The cover of the capsule is now manually folded onto the adhesive surface and thereby closes the hollow space. Filling of the capsule can take place preferably just a short time before the preparation in excess pressure presses, such as, for example, coffee machines, in order to maintain the aromas, for example, in the original package of the coffee manufacturer.

In accordance with another further development of the invention, the flange-like rim is defined by a profiled circumference. This provides the circular cover with a guidance and a lateral border when the cover is folded down and fixed to the adhesive surface.

The filter arranged on the inner side of the cup-shaped container extends over the entire bottom and at least partially over the side wall of the container. In accordance with another feature of the invention, the filter is arranged at a distance from the bottom of the container so as to form at least one intermediate space. This ensures that when one or more inlet openings are made in the container bottom, for example, by means of a mandrel, the water cannot damage the filter and this arrangement prevents the return flow of solids from the capsule into the coffee machine. This intermediate space between filter and container bottom is empty or it is possible to arrange in this intermediate space a non-woven fabric or similar porous material.

The enclosed capsule is suitable for being placed in the pressure chamber of coffee machine. When places in the machine, the capsule wall is punctured in order to facilitate the entry of hot water or a steam/water mixture. The hot water which penetrates through the aromatic solids leaves the capsule through openings in the capsule cover. The openings in the capsule cover can be provided by puncturing from the outside or by bursting of the cover head intended breaking points.

Another advantageous property of the container constructed in accordance with the invention is that the capsules can be stacked one within the other, so that a clear space savings is achieved as compared to already sealed coffee capsules, and the result of a protective effect of the open capsules relative to the deformation prior to the filling of the capsule is achieved.

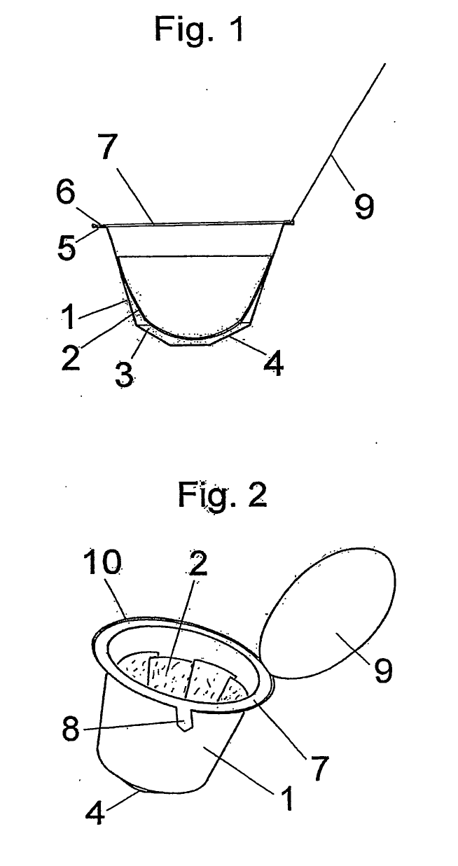

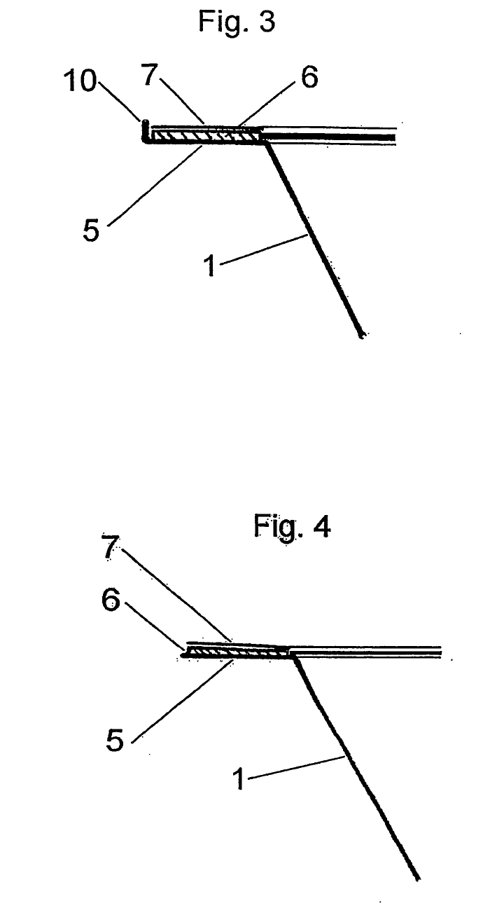

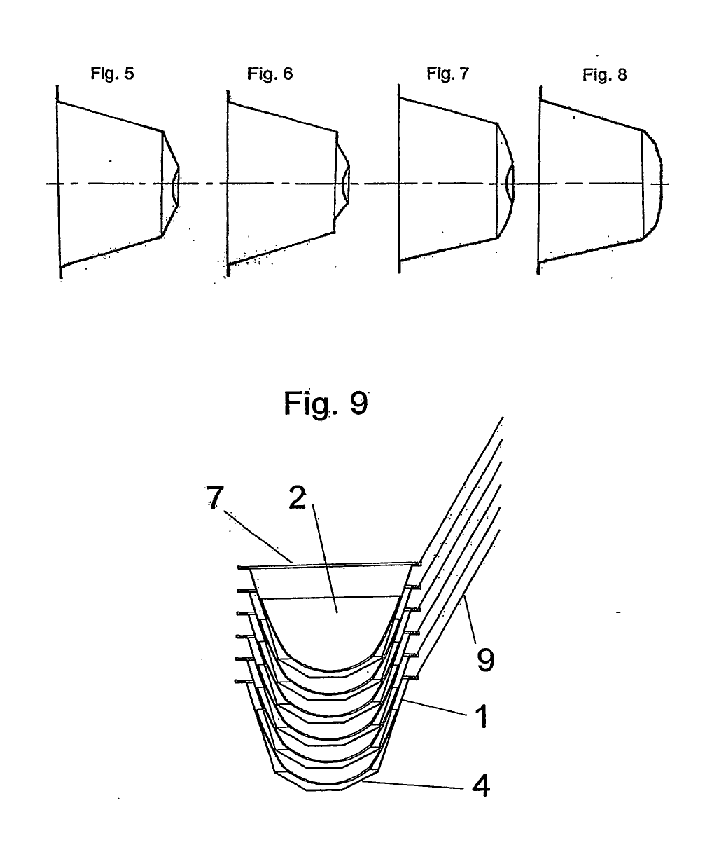

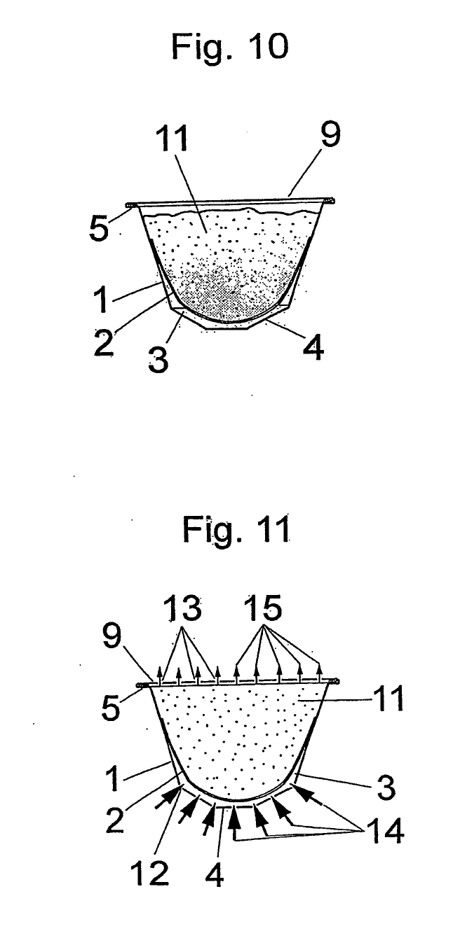

The invention will be defined with the aid of the drawings, wherein FIG. 1 is a sectional view taken from FIG. 2 of an open unfilled capsule, FIG. 2 is a perspective view of the capsule itself, FIG. 3 and FIG. 4 show possible details of the sectional view of FIG. 1, particularly the flange-like rim and finally, FIG. 5, FIG. 6, FIG. 7 and FIG. 8 show possible further developments of the cup-shaped container, FIG. 9 shows the stackability of the open unfilled capsules, FIG. 10 shows a filled and manually closed capsule, and FIG. 11 shows the entry of steam or hot water into the capsule and the outflow of aromatized water.

FIG. 1 shows a cup-shaped container 1 in whose inner side a filter 2 is mounted in such a way that an intermediate space 3 exists between filter 2 and bottom 4 of the container 1. The container 1 has at the open side thereof a flange-like rim 5 which is provided with an adhesive surface 6 which itself is provided with an easily removable annular cover 7. FIG. 1 shows an additional open cover 9 which is secured to the flange-like rim 5. The cover 9 can be pressed after filling the container 1 with, for example, coffee powder 11, as also illustrated in FIG. 10, and after removal of the annular cover 7, manually against the adhesive surface 6 of the flange-like rim 5 and thereby closes the container 1.

FIG. 2 shows an oblique view of the open unfilled container 1 and the arrangement as shown in FIG. 1. A pull lug 8 is provided at the cover 7 for removing the cover 7 from the adhesive surface 6 of the flange-like rim 5, as also illustrated in FIG. 1. The pull lug 8 is arranged at the outer circumference of the annular cover 7, as shown in FIG. 2, preferably outside of the area of the cover 9 which is pivotally fastened to the container 1.

FIG. 3 shows the flange-like rim 5, the adhesive surface 6 as well as the removable annular cover 7 and the profiled circumference 10 which serves as a guidance and lateral border when closing the container 1 with the cover 9.

FIG. 4 shows the same arrangement as that illustrated in FIG. 3, however, in another embodiment without profile 10.

FIG. 5, FIG. 6, FIG. 7 and FIG. 8 each show possible configurations of the cup-shaped container 1 with a stepped conical, stepped spherical shape, as well as different combinations of conical and spherical shapes.

FIG. 9 shows the stackability of open capsules, wherein a container 1 protrudes into one of the filters 2 of the stacked capsules. The capsules are aligned relative to each other in such a way that the covers 9 of all capsules stacked into each other are located one above the other. Consequently, because of the stackability of the capsules, it is possible to stack a significantly higher number of capsules in a sales package than is possible in an already sealed coffee capsule. Moreover, the container 1, filter 2 and cover 9 are protected by being stacked by one another against deformation of the capsule prior to filling and manual closing.

FIG. 10 shows a capsule which is already filled, for example, with coffee powder 11, wherein the intermediate space 3 and the closed cover 9 at the flange-like rim 5 are visible. In contrast to already sealed capsules, the arrangement according to the present invention is not under negative pressure, which means that the cover 9 is not curved outwardly and the adhesive surface 6 does not have to absorb higher loads.

FIG. 11 shows that the container 1 is punctured at the bottom 4 and any selected location 12 when being placed in the pressure chamber of a coffee machine and hot water or a steam/water mixture 14 flows into the intermediate space 3. The hot water 14 penetrates the coffee powder 11 and emerges from the capsule through openings 13 provided in the cover 9 as an aromatic solution 15. As is the case in already known configurations of coffee machines, the openings 13 can be produced by edges which act from the outside or by pressurized bursting of the cover 9 along intended breaking points. This results in small hook-like crack edges which produce a sieve effect in order to retain solids. In this arrangement, an advantageous effect is produced in that the sieve-like crack edges at the cover lead to a sludge effect in the coffee. It can also be seen that the intermediate space 3 is substantially free of coffee powder 11 and, thus, a return flow of solid particles through the openings 12 is prevented.

We claim:

1. Cup-shaped container which is open at the top with an opening which can be closed by a cover, and with an outwardly protruding flange-like rim and a filter arranged at the inner side of the container, characterized in that the flange-like rim (5) is provided on its upper side with an adhesive surface (6), wherein an annular cover (7) is arranged releasably on the surface (6), and a cover (9) for closing the container (1) is pivotally arranged in the area of the upper rim of the container (1).

2. Container according to claim 1, characterized in that the cover (9) can be pivoted through a folding edge.

3. Container according to claim 1 or 2, characterized in that a pull lug (8) is provided at the annular cover (7) preferably outside of the area of the cover (9) which is pivotally arranged on the container (1).

4. Container according to claim 1, characterized in that the flange-like rim (5) is bordered by a profiled circumference (10).

5. Container according to claim 1, characterized in that the filter (2) is arranged at a distance from the bottom (4) of the container (1) so as to form at least one intermediate space (3).
